(19) United States
(12) Patent Application Publication
(10) Pub. No.: US 2020/0234133 A1
(43) Pub. Date: Jul. 23, 2020

(54) DATA FIXED-POINT METHOD AND DEVICE

(71) Applicant: SZ DJI TECHNOLOGY CO., LTD., Shenzhen (CN)

(72) Inventors: Sijin LI, Shenzhen (CN); Kang YANG, Shenzhen (CN); Manhong LIN, Shenzhen (CN); Zhao YAN, Shenzhen (CN)

(21) Appl. No.: 16/842,145

(22) Filed: Apr. 7, 2020

Related U.S. Application Data
(63) Continuation of application No. PCT/CN2017/106333, filed on Oct. 16, 2017.

(51) Int. Cl. G06N 3/08; G06N 3/04

(52) U.S. Cl. CPC G06N 3/082; G06N 3/04

(57) ABSTRACT

A data fixed-point method, includes: calculating a maximum output value in a first target layer of a neural network for each input sample of a plurality of input samples; selecting at least two of a plurality of maximum output values as fixed-point reference values; determining a reference integer part bit width according to each of the fixed-point reference values; and performing an accuracy test based on a preset output value total bit width and each reference integer part bit width, to determine a reference integer part bit width with a highest accuracy as an integer part bit width used by the first target layer when output values are fixed-pointed.

### CROSS-REFERENCE TO RELATED APPLICATION

This application is a continuation of International Application No. PCT/CN2017/106333, filed on Oct. 16, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data processing and, more particularly, to a data fixed-point method, and a device.

### BACKGROUND

In current neural network computing frameworks, floating-point numbers are used for training calculations. During a back propagation of a neural network, a calculation of a gradient needs to be based on floating-point numbers to ensure sufficient accuracy. Weight coefficients of each layer of a forward propagation of a neural network, especially a convolution layer and a fully connected layer, and output values of each layer, are also expressed as floating-point numbers. However, in the forward propagation, operations based on floating-point numbers are more complex in logic design than operations based on fixed-point numbers, consume more hardware resources, and consume more power. Hardware logic design based on fixed-point numbers is more friendly than hardware logic design based on floating-point numbers.

Related companies in the industry usually convert output values and weight coefficients of each layer during training calculations represented by floating-point numbers into fixed-point number representations by minimizing numerical errors. That is, an optimization objective function is set for the output values. According to the optimization objective function, and under a condition of a given bit width, a fractional part bit width is found when an error between numbers obtained after the output values are fixed-point truncated and floating-point numbers is minimized. Fixed-pointing of the weight coefficients is also realized in a similar principle. However, when a fixed-point position is determined with a minimum error of the optimized objective function, fixed-point results obtained may be poor. Taking still the output values as an example, a main reason is that most important information in the output values is often determined by output values with relatively large values, whose proportion is usually small. When a fixed-point position obtained by this existing fixed-point method is used for fixed-pointing, although a truncation rate is relatively low, most useful high bit information is often removed, thereby affecting expression ability of a network, and causing accuracy of the network to decrease.

### SUMMARY

In accordance with the disclosure, there is provided a data fixed-point method. The data fixed-point method includes: calculating a maximum output value in a first target layer of a neural network for each input sample of a plurality of input samples; selecting at least two of a plurality of maximum output values as fixed-point reference values; determining a reference integer part bit width according to each of the fixed-point reference values; and performing an accuracy test based on a preset output value total bit width and each reference integer part bit width, to determine a reference integer part bit width with a highest accuracy as an integer part bit width used by the first target layer when output values are fixed-pointed.

Also in accordance with the disclosure, there is provided a data fixed-point method. The data fixed-point method includes: calculating a reference output value of an input sample in a first target layer of a neural network; determining a preset output value total bit width and a preset first sign bit width; determining an output value integer part bit width according to a size of the reference output value; and determining an output value fractional part bit width according to the preset output value total bit width, the preset first sign bit width, and the output value integer part bit width, that the preset first sign bit width, the output value integer part bit width, and the output value fractional part bit width are used as a sign bit width, an integer part bit width, and a fractional part bit width used by the first target layer when output values are fixed-pointed.

Also in accordance with the disclosure, there is provided a data processing method. The data processing method includes: performing merging and preprocessing on at least two layers of a neural network; and performing neural network operations based on the neural network after performing the merging and the preprocessing.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic diagram of a deep convolutional neural network.

FIG. 2 is a schematic flowchart of a data fixed-point method according to an exemplary embodiment of the present disclosure.

FIG. 3A, FIG. 3B, and FIG. 3C are schematic diagrams of exemplary processes of merging and preprocessing according to various embodiments of the present disclosure; and FIG. 3D is a schematic diagram of a layer connection mode of a convolution layer followed by an activation layer.

FIG. 4 is a schematic diagram of selecting fixed-point reference values according to an exemplary embodiment of the present disclosure.

FIG. 5 is a schematic diagram of a working principle of a Concatenation layer.

FIG. 6 is a schematic diagram of postprocessing according to an exemplary embodiment of the present disclosure.

FIG. 7 is a schematic flowchart of a data fixed-point method according to an exemplary embodiment of the present disclosure.

FIG. 8 is a schematic flowchart of a data fixed-point method according to an exemplary embodiment of the present disclosure.

FIG. 9 is a schematic flowchart of a data processing method according to an exemplary embodiment of the present disclosure.

FIG. 10 is a schematic flowchart of a data alignment method according to an exemplary embodiment of the present disclosure.

FIG. 11 is a schematic block diagram of a data fixed-point device according to an exemplary embodiment of the present disclosure.

FIG. 12 is a schematic block diagram of a data fixed-point device according to an exemplary embodiment of the present disclosure.

FIG. 13 is a schematic block diagram of a data processing device according to an exemplary embodiment of the present disclosure.

FIG. 14 is a schematic block diagram of a data alignment device according to an exemplary embodiment of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Unless defined otherwise, all technical and scientific terminologies used herein have a same meaning as commonly understood by those having ordinary skills in the art to which the present disclosure is related. The terminologies used in the present disclosure are only for the purpose of describing embodiments of the present disclosure, and are not intended to limit the present disclosure.

Related technologies and concepts involved in the embodiments of the present disclosure are introduced first.

A neural network (taking a Deep Convolutional Neural Network (DCNN) as an example) is introduced below.

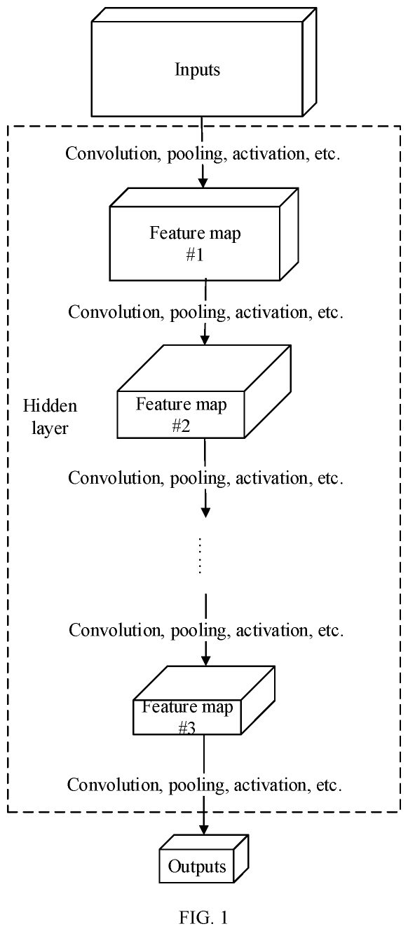

FIG. 1 is a schematic diagram of a DCNN. Input values of a DCNN (inputted from an input layer) are processed in a hidden layer with operations such as convolution, transposed convolution or deconvolution, batch normalization (BN), Scale, fully connected, Concatenation, pooling, element-wise addition, activation, etc., to obtain output values (outputted from an output layer). Operations that may be involved in a hidden layer of a neural network in the embodiments of the present disclosure are not limited to the above operations.

A hidden layer of a DCNN may include cascaded multiple layers. Inputs of each layer are outputs of an upper layer, which are feature maps. Each layer performs at least one of the operations described above on one or more sets of the feature maps of the inputs to obtain outputs of each layer. The outputs of each layer are also feature maps. In general, each layer is named after an operation it implements. For example, a layer that implements a convolution operation is called a convolution layer. In addition, a hidden layer may also include a transposed convolution layer, a BN layer, a Scale layer, a pooling layer, a fully connected layer, a Concatenation layer, an element-wise addition layer, an activation layer, etc., which are not listed here one by one. Specific operation processes of each layer can refer to existing technologies, which are not described in the present disclosure.

It should be understood that each layer (including the input layer and the output layer) may have one input and/or one output, and may also have multiple inputs and/or multiple outputs. In classification and detection tasks in a visual field, a width and a height of feature maps are often decreasing layer by layer (for example, a width and a height of an input, a feature map #1, a feature map #2, a feature map #3, and an output shown in FIG. 1 are decreasing layer by layer). In semantic segmentation tasks, after being reduced to a certain depth, a width and a height of feature maps may be increased layer by layer through a transposed convolution operation or an upsampling operation.

Normally, a convolution layer is followed by an activation layer, and common activation layers include a Rectified Linear Unit (ReLU) layer, a sigmoid layer, a tanh layer, etc. After a BN layer is provided, more and more neural networks perform a BN operation after a convolution operation, and then perform an activation operation.

Currently, layers that require more weight coefficients for operations are: convolution layers, fully connected layers, transposed convolution layers, and BN layers.

Floating-point numbers and fixed-point numbers are introduced below.

The floating-point numbers include single-precision floating-point numbers (32-bit) and double-precision floating-point numbers (64-bit). A fixed-point number is expressed with a sign bit, an integer part, and a fractional part. bw is a total bit width of a fixed-point number, s is the sign bit (usually placed at a leftmost bit), fl is a fractional part bit width, and xᵢ is a value of each bit (also known as a mantissa). A real value of a fixed-point number can be expressed as:

$$x = {( - 1 )}^{s} \times {2}^{- fl} \times {\sum }_{i = 0}^{b w - 2} {2}^{i} \times {x}_{i} .$$

For example, a fixed-point number is 01000101, the total bit width is 8 bits, the highest bit (0) is the sign bit, and the fractional part bit width fl is 3. Then a real value represented by this fixed-point number is:

x=(−1)⁰×2⁻³×(2⁰+2²+2⁶)=8.625 .

An existing fixed-point method is introduced below.

In an existing fixed-point method, fixed-pointing of data mainly includes fixed-pointing of weight coefficients and fixed-pointing of output values of a convolution layer or a fully connected layer. An existing fixed-point method is achieved by minimizing numerical errors.

For fixed-pointing of weight coefficients of each layer, there can be an optimization objective function. The optimization objective function of the weight coefficients is to find a fractional part bit width when an error between numbers obtained after the weight coefficients are fixed-point truncated and floating-point numbers is minimized, for a given total bit width.

For fixed-pointing of output values of a convolution layer or a fully connected layer, there can also be an optimization objective function. Its fixed-point principle is similar to a fixed-point principle of the weight coefficients.

When a fixed-point position is determined with a minimum error of an optimized objective function, fixed-point results obtained may be poor. Taking still output values as an example, a main reason is that most important information in the output values is often determined by output values with relatively large values, whose proportion is usually small. When a fixed-point position obtained by the existing fixed-point method is used for fixed-pointing, although a truncation rate is relatively low, most useful high bit information is often removed, thereby causing accuracy of a network to decrease.

The existing fixed-point method does not consider fixed-point processing of layers other than a convolution layer and a fully connected layer, especially an activation layer, a pooling layer, and a BN layer, which may all involve floating-point operations, therefore fixed-point processing needs to be considered.

The existing fixed-point method does not consider a problem of aligning decimal points of data inputted to an element-wise addition layer, a Concatenation layer, etc. This may cause that data has to be shifted during operations after the data is fixed-pointed, which makes an operation process more complicated.

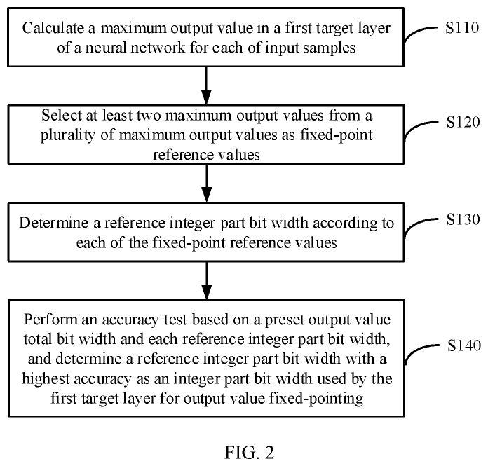

In view of the above problems, the embodiments of the present disclosure provide a data fixed-point method 100, and FIG. 2 is a schematic flowchart of the data fixed-point method 100. The method 100 includes S110, S120, S130, and 140.

In S110, a maximum output value in a first target layer of a neural network is calculated for each input sample of a plurality of input samples.

In S120, at least two maximum output values from a plurality of maximum output values are selected as fixed-point reference values.

In S130, a reference integer part bit width according to each of the fixed-point reference values is determined.

In S140, an accuracy test based on a preset output value total bit width and each reference integer part bit width is performed, and a reference integer part bit width with a highest accuracy is determined as an integer part bit width used by the first target layer when output values are fixed-pointed.

In the embodiments of the present disclosure, a plurality of values are selected from a plurality of maximum output values of a first target layer as fixed-point reference values, a reference integer part bit width is determined corresponding to each of the fixed-point reference values, and an optimal integer part bid width is determined based on accuracy tests. Basing on the optimal integer part bit width can make a network after fixed-pointing to transmit more useful information while maintaining high accuracy, and improve expression ability and accuracy of the network.

It should be understood that after a reference integer part bit width is determined in the embodiments of the present disclosure, a reference fractional part bit width can be obtained based on a preset output value total bit width. Or in other embodiments, a reference fractional part bit width can be obtained first, and then a reference integer part bit width can be obtained, which is not limited in the embodiments of the present disclosure.

In some embodiments, a sign bit may exist after data is fixed-pointed (for example, a sign bit width is a first sign bit width). A sum of a first sign bit width, a reference integer part bit width, and a reference fractional part bit width is equal to a preset output value total bit width.

It should also be understood that during fixed-pointing after a fixed-point solution is determined, a first sign bit is determined according to positive and negative values of data to be fixed-pointed; and an integer part and a fractional part after fixed-pointing are determined according to values (sizes) of the data to be fixed-pointed, which are not described in detail in the embodiments of the present disclosure.

A first target layer in the embodiments of the present disclosure may include one layer of, or a layer merged from at least two layers of a convolution layer, a transposed convolution layer, a BN layer, a Scale layer, a pooling layer, a fully connected layer, a Concatenation layer, an element-wise addition layer, and an activation layer. That is, the data fixed-point method according to the embodiments of the present disclosure can be applied to any one or more layers of a hidden layer of a neural network.

Corresponding to cases where a first target layer is a layer merged from at least two layers, the data fixed-point method 100 may further include: merging and preprocessing at least two layers of a neural network to obtain a first target layer formed after merging. This process can be considered as a preprocessing part of the data fixed-point method.

After a training phase of a neural network is completed, parameters of a convolution layer, a BN layer and a Scale layer of an inference phase are fixed. It can be known through calculations and derivations that parameters of a BN layer and a Scale layer can be combined into parameters of a convolution layer, so that an Intellectual Property core (IP core) of a neural network does not need to specifically design a dedicated circuit for the BN layer and the Scale layer.

In early neural networks, a convolution layer is followed by an activation layer. To prevent a network from overfitting, accelerate a convergence speed, enhance generalization ability of the network, etc., a BN layer can be introduced before the activation layer and after the convolution layer. Inputs of the BN layer include B={x₁, . . . , xₘ}={xᵢ} and parameters γ and β, where xᵢ are both outputs of the convolution layer and the inputs of the BN layer, and the parameters γ and β are calculated during a training phase and are constants during an inference phase. Outputs of the BN layer are {yᵢ=BN_{γ, β}(xᵢ)}.

Where,

$${y}_{i} ← γ {\hat{x}}_{i} + β ≡ B {N}_{γ , β} ( {x}_{i} ) , \\ {\hat{x}}_{i} ← \frac{{x}_{i} - {μ}_{B}}{\sqrt{{σ}_{B}^{2} + ɛ}} , \\ {μ}_{B} ← \frac{1}{m} {\sum }_{i = 1}^{m} {x}_{i} , and$$

$${σ}_{B}^{2} ← \frac{1}{m} {\sum }_{i = 1}^{m} {( {x}_{i} - {μ}_{B} )}^{2} .$$

Therefore calculations of \hat{x}ᵢ and yᵢ can be simplified as:

$${\hat{x}}_{i} = \frac{{x}_{i} - {μ}_{B}}{α} , and$$

$${y}_{i} = γ \frac{{x}_{i} - {μ}_{B}}{α} + β = \frac{γ}{α} {x}_{i} + β - \frac{γ \times {μ}_{B}}{α} = {ax}_{i} + b .$$

xᵢ are the outputs of the convolution layer. Let X be inputs of the convolution layer, W be a weight coefficient matrix, and b̅ be an offset value:

xᵢ=WX+b̅, and

yᵢ=aWX+b̅+b=\tilde{W}X+b̅.

Thus, merging of the convolution layer and the BN layer is completed.

A Scale layer itself is to calculate yᵢ=axᵢ+b. Referring to merging of a BN layer and a convolution layer, a Scale layer and a convolution layer can also be merged. Under a Caffe framework, outputs of a BN layer are \hat{x}ᵢ. Therefore, a neural network designed based on a Caffe framework usually adds a Scale layer after a BN layer to achieve a complete batch normalization.

Therefore, merging and preprocessing at least two layers of a neural network to obtain a first target layer formed after merging may include: merging and preprocessing a convolution layer and a BN layer of the neural network to obtain the first target layer; or , merging and preprocessing a convolution layer and a Scale layer of the neural network to obtain the first target layer; or merging and preprocessing a convolution layer, a BN layer, and a Scale layer of the neural network to obtain the first target layer.

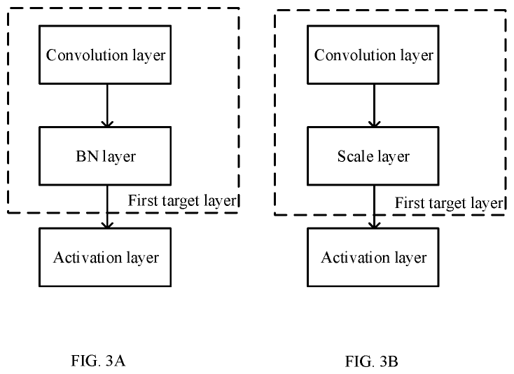

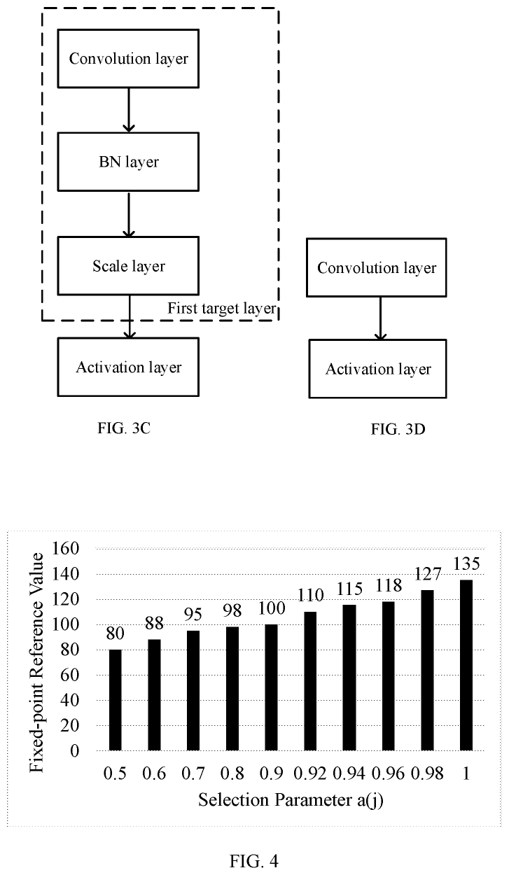

FIG. 3A, FIG. 3B and FIG. 3C are schematic diagrams of exemplary processes of merging and preprocessing according to various embodiments of the present disclosure. FIG. 3D is a simplest layer connection mode of a convolution layer followed by an activation layer.

As shown in FIG. 3A, before merging and preprocessing are performed, a convolution layer is followed by a BN layer, and then an activation layer. The convolution layer and the BN layer are merged into a first target layer, followed by the activation layer, to obtain a two-layer structure similar to FIG. 3D.

It should be understood that some IP cores support processing of a Scale layer, then merging of a convolution layer and a BN layer in merging and preprocessing can be replaced by merging of a convolution layer and a Scale layer. As shown in FIG. 3B, before merging and preprocessing are performed, a convolution layer is followed by a Scale layer, and then an activation layer. The convolution layer and the Scale layer are merged into a first target layer, followed by the activation layer, to obtain a two-layer structure similar to FIG. 3D.

As shown in FIG. 3C, before merging and preprocessing, a convolution layer is followed by a BN layer, then a Scale layer, and then an activation layer. The convolution layer, the BN layer, and the Scale layer are merged into a first target layer, followed by the activation layer, to obtain a two-layer structure similar to FIG. 3D.

It should be understood that after merging and preprocessing, a maximum output value in S110 is a maximum output value in a first target layer formed after merging for each input sample of a plurality of input samples.

Through S110 to S140 of the data fixed-point method 100, a fixed-point position of output values of a first target layer can be determined.

In S110, a maximum output value in a first target layer of a neural network is calculated for each input sample of a plurality of input samples. Alternatively, the plurality of input samples constitutes an input data set. A forward propagation calculation is performed on multiple, for example, M samples of the input data set, and a maximum output value for each sample in a first target layer to be fixed-pointed is recorded, to obtain M maximum values. M is a positive integer greater than or equal to two. It should be noted that to ensure calculation accuracy in the forward propagation calculation, floating-point numbers can still be used for weight coefficients.

In S120, selecting at least two maximum output values from a plurality of maximum output values as fixed-point reference values may include: sorting the plurality of maximum output values, and selecting at least two maximum output values from the plurality of maximum output values according to preset selection parameters, to be used as the fixed-point reference values. It should be understood that selection parameters may be within a preset range.

Alternatively, multiple maximum output values (for example, M maximum output values) are sorted, for example, in an ascending order or in a descending order, or according to a preset rule. After sorting, N maximum output values are selected from the M maximum output values according to preset selection parameters (for example, selection parameters are to select values at specific positions after sorting). N is a positive integer less than or equal to M.

FIG. 4 is a schematic diagram of selecting fixed-point reference values according to an exemplary embodiment of the present disclosure. In one alternative example, M maximum output values are arranged in an ascending order, selection parameters are a(j), and a(j)×M maximum output values are selected as fixed-point reference values, where j's value is 1, . . . , N, and a(j) is greater than or equal to 0 and less than or equal to 1. For example, N can be equal to 10, and a(1), . . . , a(10) are 0.5, 0.6, 0.7, 0.8, 0.9, 0.92, 0.94, 0.96, 0.98, 1, respectively.

In some embodiments, the selection parameters a(j) may be a selection of a maximum value and a next largest value. In other embodiments, the selection parameters a(j) may be uniform values, for example, 0.1, 0.2, 0.3, . . . , 1, etc. A method of selecting the fixed-point reference values is not limited here.

In S130, determining a reference integer part bit width according to each of the fixed-point reference values may include: determining the reference integer part bit width according to a size of the fixed-point reference values. In some embodiments, the method 100 may further include: determining a preset first sign bit width and a preset output value total bit width; and determining a reference fractional part bid width according to the preset first sign bit width, the preset output value total bit width, and the reference integer part bit width. In the embodiments of the present disclosure, a first sign bit and a reference integer part may be considered as a reference non-fractional part. In other words, a reference non-fractional part bit width includes a first sign bit width (generally the first sign bit width is 1) and a reference integer part bit width. Alternatively, for example, a j-th fixed-point reference value of the N fixed-point reference values is Oj. bwo is a preset output value total bit width. A reference non-fractional part bit width is determined according to a size of the fixed-point reference value Oj. For example, if the reference non-fractional part bit width is iwoj=ceil(log₂(Oj)+1), then the fixed-point reference value Oj corresponds to a reference fractional part bit width fwoj=bwo−iwoj, where j is 1, . . . , N, and ceil( ) means round up. It should be understood that the reference non-fractional part bit width includes a first sign bit width (the first sign bit width is 1) and a reference integer part bit width iwoj−1.

In other embodiments, there is no sign bit after data is fixed-pointed. In S130, determining a reference integer part bit width according to each of the fixed-point reference values may include: determining a reference integer part bit width according to a size of the fixed-point reference values. Alternatively, in the embodiments of the present disclosure, for example, a j-th fixed-point reference value of the N fixed-point reference values is Oj. bwo is a preset output value total bit width. A reference integer part bit width is determined according to a size of the fixed-point reference value Oj. For example, the reference integer part bit width iwoj=ceil(log₂(0j)), then the fixed-point reference value Oj corresponds to a reference fractional part bit width fwoj=bwo−iwoj, where: j is 1, . . . , N, and ceil( )means round up.

In S140, an accuracy test based on a preset output value total bit width and each reference integer part bit width is performed, and a reference integer part bit width with a highest accuracy is determined as an integer part bit width used by the first target layer when output values are fixed-pointed.

Alternatively, the first target layer has N possible fixed-point solutions, and one fixed-point solution with a least prediction accuracy loss. In the example of FIG. 4, when a(j) is equal to 0.98, that is, when a fixed-point reference value is 127, the prediction accuracy loss is the smallest. Taking an exemplary case where a sign bit exists as an example, a non-fractional part bit width of the first target layer iwoj is equal to 8 (1 sign bit, and 7 integer bits). If an output value total bit width is 16 bits, a fractional part bit width is equal to 16−8=8.

The above describes a process of determining a fixed-point solution of output values. The data fixed-point method may further include a process of determining a fixed-point solution of weight coefficients, including: determining a preset weight fixed-point total bit width and a preset second sign bit width for weight coefficients; determining a weight integer part bit width according to a size of a largest weight coefficient in a first target layer; and determining a weight fractional part bit width according to the preset weight fixed-point total bit width, the preset second sign bit width, and the weight integer part bit width, where the preset second sign bit width, the weight integer part bit width, and the weight fractional part bit width are determined as a sign bit width, an integer part bit width, and a fractional part bit width used by the first target layer when weight coefficients are fixed-pointed.

A process of determining a fixed-point solution of weight coefficients is similar to a process of determining a fixed-point solution of output values. A difference is that a maximum weight coefficient is found directly from a first target layer, and a weight non-fractional part bit width can be determined according to a size of the maximum weight coefficient. In an alternative example, a weight fixed-point total bit width for weight coefficients may be bww. A weight non-fractional part bit width iww=ceil(log₂(w)+1) is calculated corresponding to a maximum weight coefficient w in a first target layer, including a second sign bit width and a weight integer part bit width. Therefore, a weight fractional part bit width corresponding to the maximum weight coefficient w is fww=bww−iww. The second sign bit width (usually 1 bit), the weight integer part bit width iww−1, and the weight fractional part bit width fww are determined as a sign bit width, an integer part bit width, and a fractional part bit width used by the first target layer when weight coefficients are fixed-pointed.

It should be understood that if there exists merging and preprocessing, a maximum weight coefficient is a maximum value of weight coefficients in a first target layer formed after merging at least two layers of a neural network.

Optionally, the embodiments of the present disclosure may include postprocessing to solve a problem that some layers have a need to align decimal points of input data. Therefore, decimal points of output values of at least two upper layers (for example, including a first target layer and a second target layer) need to be aligned. The data fixed-point method 100 may further include: determining an integer part bit width used by a second target layer of a neural network when output values are fixed-pointed, so that the integer part bit width used by the second target layer when output values are fixed-pointed is equal to an integer part bit width used by a first target layer when output values are fixed-pointed.

In cases where a preset output value total bit width of a system is a constant, because an integer part bit width used by a second target layer when output values are fixed-pointed is equal to an integer part bit width used by a first target layer when output values are fixed-pointed, it should be understood that a fractional part bit width used by the second target layer when output values are fixed-pointed is also equal to a fractional part bit width used by the first target layer when output values are fixed-pointed.

When a first target layer and a second target layer have different fixed-point positions determined by their respective fixed-point solutions of output values, that is, when integer part bit widths are different, determining an integer part bit width used by a second target layer of a neural network when output values are fixed-pointed includes: a maximum integer part bit width that should be used by a first target layer and a second target layer when output values are fixed-pointed is determined as an integer part bit width finally used by the first target layer and the second target layer when output values are fixed-pointed. For example, according to their respective fixed-point solutions of output values, a non-fractional part bit width of a first target layer is 7 (a first sign bit width is 1, and an integer part bit width is 6), and a non-fractional part bit width of a second target layer is 5 (a first sign bit width is 1, and an integer part bit width is 4). To ensure that an integer part is not truncated, a non-fractional part bit width finally used by the first target layer and the second target layer when output values are fixed-pointed may be 7. The non-fractional part bit width 7 may include 1 as a sign bit and 6 as an integer bit. If a preset output value total bit width is 16, a fractional part bit width is 9.

Optionally, output values of a first target layer and output values of a second target layer are post-processed in a Concatenation layer and/or an element-wise addition layer. According to different types of layers supported by an IP core, output values after decimal point alignment can also be processed in other layers, which is not limited in the embodiments of the present disclosure.

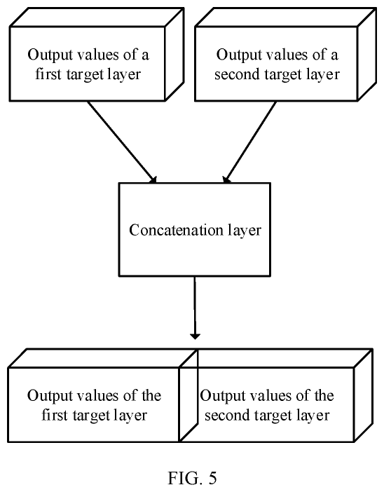

Alternatively, postprocessing is mainly aimed at a Concatenation layer and an element-wise addition layer, so positions of decimal points of input values (that is, input feature maps) of these two layers are aligned. A function implemented by a Concatenation layer is to merge two sets of input feature maps together to achieve an effect of merging features. In a computer, it can be understood as two discrete memory blocks are stitched into a continuous memory block. FIG. 5 shows a schematic diagram of a working principle of a Concatenation layer. A function implemented by an element-wise addition layer is to perform a point addition operation on two sets of input feature maps to calculate a residual feature map. Since positions of decimal points of two sets of input feature maps may be inconsistent, these two layers need to perform decimal point alignment on values of the two sets of input feature maps. Although the decimal point alignment of the values of the input feature maps can be achieved by shifting by hardware, doing so will waste certain hardware resources. The two sets of feature maps inputted in the Concatenation layer or the element-wise addition layer are feature maps outputted by two layers (for example, including a first target layer and a second target layer), and a fixed-point process can be performed when the two layers produce outputs, so output values of the two layers only need to be decimal points aligned. The postprocessing in the embodiments of the present disclosure can reduce a use of hardware resources and improve system efficiency.

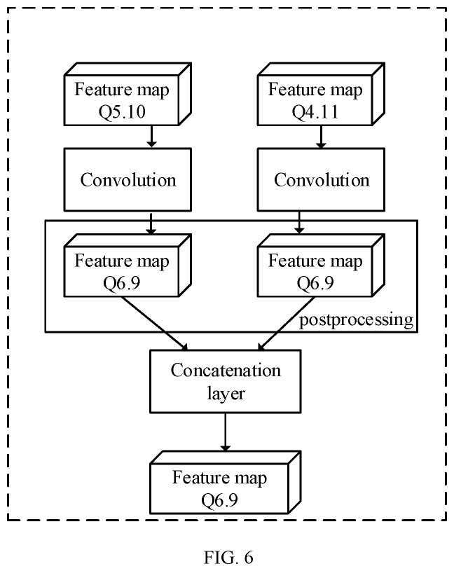

FIG. 6 is a schematic diagram of postprocessing according to an exemplary embodiment of the present disclosure. In an existing processing solution, a feature map with a data format of Q5.10 is subjected to a convolution operation to obtain a feature map with a data format of Q4.11, and a feature map with a data format of Q4.11 is subjected to a convolution operation to obtain a feature map with a data format of Q6.9. The obtained feature map with a data format of Q4.11 can convert the data format to the data format Q6.9 after shifting, and can be used with the obtained feature map with a data format of Q6.9 as inputs of a Concatenation layer, and after an operation of a Concatenation layer, a feature map with a data format of Q6.9 (an output of the Concatenation layer) is obtained. As shown in FIG. 6, a solution of one embodiment of the present disclosure is: obtaining a feature map with a data format of Q6.9, after a feature map with a data format of Q5.10 is performed with convolution operations combining postprocessing (determining that the data format should be Q6.9); obtaining a feature map with a data format of Q6.9, after a feature map with a data format of Q4.11 is performed with convolution operations combining postprocessing (determining that the data format should be Q6.9); and using two obtained feature maps with a data format of Q6.9 as inputs of a Concatenation layer, and obtaining a feature map with a data format of Q6.9 (an output of the Concatenation layer) after an operation of the Concatenation layer.

It should be understood that the solution in FIG. 6 is only an alternative embodiment of the present disclosure. In other embodiments, using still the above example as an example, postprocessing can select to align in a data format of Q4.11, that is, to ensure that a maximum number of decimal places is used as a standard to align; or in other embodiments, a bit width for aligning can be selected according to other standards; which is not limited in the embodiments of the present disclosure.

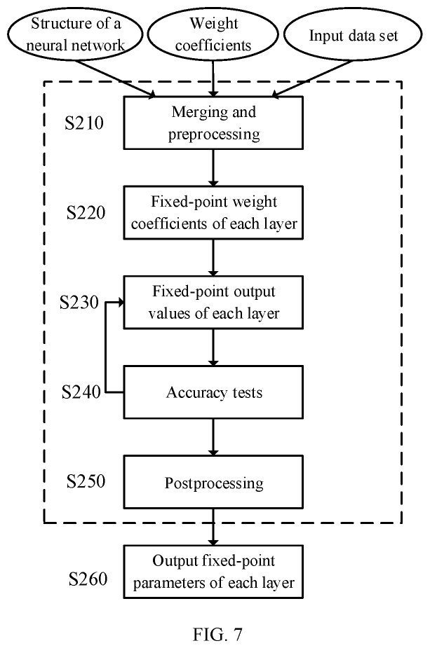

FIG. 7 is a schematic flowchart of a data fixed-point method according to an exemplary embodiment of the present disclosure. As shown in FIG. 7, determining a data fixed-point solution requires obtaining a structure of a neural network, weight coefficients of each layer, and an input data set used to determine the fixed-point solution. The structure of the neural network refers to types of layers that the neural network includes. According to the structure of the neural network, merging and preprocessing of S210 is performed. After that, S220 may be performed to determine a fixed-point solution of the weight coefficients of each layer. According to the input data set, output values of each layer are obtained, and fixed-pointing of the output values of each layer of S230 is performed, and results of accuracy tests of S240 are used to determine a fixed-point solution of the output values of each layer. Finally, S250 postprocessing can be performed. According to results of S210 to S250, fixed-point parameters of the weight coefficients and the output values of each layer are outputted, for example, a non-fractional part bit width, or a non-fractional part bit width and a fractional part bit width, or an integer part bit width and a fractional part bit width, or a sign bit width, an integer part bit width, and a fractional part bit width, and so on.

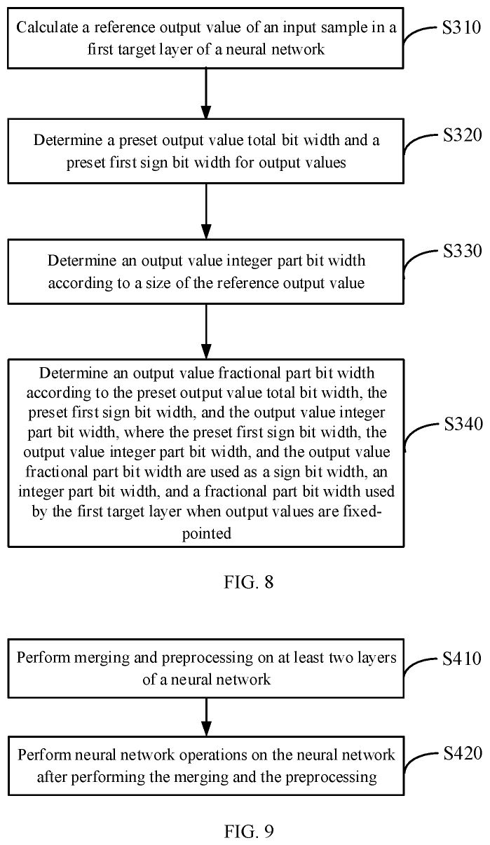

One embodiment of the present disclosure further provides a data fixed-point method. FIG. 8 is a schematic flowchart of a data fixed-point method 300 according to an exemplary embodiment of the present disclosure. The data fixed-point method 300 may include S310, S320, S330, and S340.

In S310, a reference output value of an input sample in a first target layer of a neural network is calculated.

In S320, a preset output value total bit width and a preset first sign bit width for output values are determined.

In S330, an output value integer part bit width is determined according to a size of the reference output value.

In S340, an output value fractional part bit width is determined according to the preset output value total bit width, the preset first sign bit width, and the output value integer part bit width, where the preset first sign bit width, the output value integer part bit width, and the output value fractional part bit width are used as a sign bit width, an integer part bit width, and a fractional part bit width used by the first target layer when output values are fixed-pointed.

The data fixed-point method in one embodiment of the present disclosure considers a sign bit when output values are fixed-pointed, so that a determined fixed-point solution is better, and possibility of increasing accuracy of the network is improved.

It should be understood that a reference output value in one embodiment of the present disclosure may be a single value or a plurality of reference output values generated from a plurality of input samples. A reference output value may be a maximum output value of an input sample in a first target layer, or may be a next-largest output value or another value other than the maximum output value. According to accuracy tests, an optimal fixed-point solution is determined from fixed-point solutions corresponding to multiple reference output values (for example, multiple maximum output values). Process details have been described in the foregoing embodiments, and are not repeated here.

Optionally, taking a reference output value being a maximum output value as an example, a non-fractional part bit width can be determined according to a size of a maximum output value O, for example, the non-fractional part bit width iwo=ceil(log₂(O)+1), then a fractional part bit width fwo=bwo−iwo, ceil( )means round up. It should be understood that the non-fractional part bit width may include a first sign bit width (generally, the first sign bit width is 1) and an integer part bit width iwo−1. The non-fractional part bit width may also have no sign bit, and only an integer part bit width iwo is included.

Optionally, as one embodiment, the data fixed-point method 300 may further include: determining a preset weight fixed-point total bit width and a preset second sign bit width for weight coefficients; determining a weight integer part bit width according to a size of a maximum weight coefficient of a first target layer; and determining a weight fractional part bit width according to the preset weight fixed-point total bit width, the preset second sign bit width, and the weight integer part bit width, where the preset second sign bit width, the weight integer part bit width, and the weight fractional part bit width are determined as a sign bit width, an integer part bit width, and a fractional part bit width used by the first target layer when weight coefficients are fixed-pointed.

Optionally, as one embodiment, the data fixed-point method 300 may further include: merging and preprocessing at least two layers of a neural network to obtain a first target layer formed after merging.

Optionally, as one embodiment, a reference output value is a reference output value in a first target layer formed after merging for each of a plurality of input samples.

Optionally, as one embodiment, a maximum weight coefficient is a maximum value of weight coefficients of a first target layer formed after merging and preprocessing at least two layers of a neural network.

Optionally, as one embodiment, merging and preprocessing at least two layers of a neural network to obtain a first target layer formed after merging may include: merging and preprocessing a convolution layer and a BN layer of the neural network to obtain the first target layer; or merging and preprocessing a convolution layer and a Scale layer of the neural network to obtain the first target layer; or merging and preprocessing a convolution layer, a BN layer, and a Scale layer of the neural network to obtain the first target layer.

Optionally, as one embodiment, a first target layer may include one layer of, or a layer merged from at least two layers of a convolution layer, a transposed convolution layer, a BN layer, a Scale layer, a pooling layer, a fully connected layer, a Concatenation layer, an element-wise addition layer, and an activation layer.

Optionally, as one embodiment, the data fixed-point method 300 may further include: determining an integer part bit width used by a second target layer of a neural network when output values are fixed-pointed, so that the integer part bit width used by the second target layer of the neural network when output values are fixed-pointed is equal to an integer part bit width used by a first target layer of the neural network when output values are fixed-pointed.

Optionally, as one embodiment, a fractional part bit width used by a second target layer when output values are fixed-pointed is equal to a fractional part bit width used by a first target layer when output values are fixed-pointed.

Optionally, as one embodiment, output values of a first target layer and output values of a second target layer are post-processed at a Concatenation layer and/or an element-wise addition layer.

For process details of the foregoing optional embodiments, references may be made to the foregoing descriptions, and details are not described herein again.

One embodiment of the present disclosure further provides a data processing method. FIG. 9 is a schematic flowchart of a data processing method 400 according to an exemplary embodiment of the present disclosure. The data processing method 400 may include S410 and S420.

In S410, merging and preprocessing are performed on at least two layers of a neural network.

In S420, neural network operations are performed on the neural network after performing the merging and the preprocessing.

The data processing method according to the embodiments of the present disclosure performs merging and preprocessing on the at least two layers of a neural network, and performs operations based on the neural network after performing the merging and the preprocessing, which can save computing resources and improve system efficiency.

Optionally, as one embodiment, in S410, merging and preprocessing on the at least two layers of a neural network may include: merging and preprocessing a convolution layer and a BN layer of the neural network; or merging and preprocessing a convolution layer and a Scale layer of the neural network; or merging and preprocessing a convolution layer, a BN layer and a Scale layer of the neural network.

Optionally, as one embodiment, the data processing method 400 may further include: determining weight coefficients of a first target layer formed after performing the merging and the preprocessing of the at least two layers.

Optionally, as one embodiment, in S420, performing neural network operations on the neural network after performing the merging and the preprocessing includes: performing fixed-point calculations on a first target layer formed after performing the merging and the preprocessing of the at least two layers.

Optionally, as one embodiment, performing fixed-point calculations on a first target layer formed after performing the merging and the preprocessing of the at least two layers may include: determining an integer part bit width used by the first target layer for fixed-pointing according to the data fixed-point method 100 or 200 described above.

For process details of the foregoing optional embodiments, references may be made to the foregoing description, and details are not described herein again.

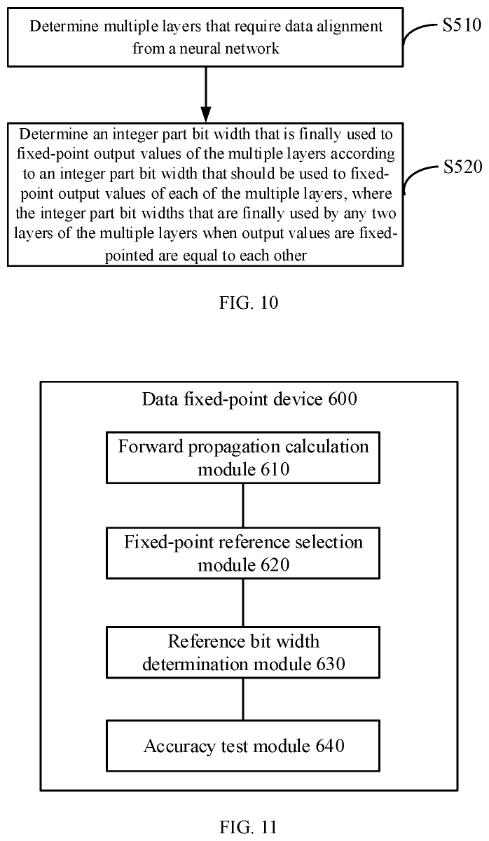

One embodiment of the present disclosure further provides a data alignment method. FIG. 10 is a schematic flowchart of a data alignment method 500 according to an exemplary embodiment of the present disclosure. The data alignment method 500 may include S510 and S520.

In S510, multiple layers that require data alignment are determined from a neural network.

In S520, an integer part bit width that is finally used to fixed-point output values of the multiple layers is determined according to an integer part bit width that should be used to fixed-point output values of each of the multiple layers, where the integer part bit widths that are finally used by any two layers of the multiple layers when output values are fixed-pointed are equal to each other.

The data alignment method in the embodiments of the present disclosure can solve the problem that some layers have an input data decimal point alignment requirement when determining a fixed-point solution, reduce a use of hardware resources, and improve system efficiency.

Optionally, as one embodiment, the data alignment method 500 may further include: determining an integer part bit width that should be used to fixed-point output values of each of the multiple layers according to the data fixed-point method 100 or 200 described above.

Optionally, as one embodiment, fractional part bit widths to fixed-point output values finally used by any two layers of the multiple layers are equal.

Optionally, as one embodiment, in S520, determining the integer part bit width that is finally used to fixed-point output values of the multiple layers may include: determining a maximum value of all the integer part bit widths that should be used for fixed-pointing output values of the multiple layers to be the integer part bit width that is finally used to fixed-point output values of the multiple layers.

It should be understood that, in S520, determining the integer part bit width that is finally used to fixed-point output values of the multiple layers may also include: determining a minimum value of all the integer part bit widths that should be used for fixed-pointing output values of the multiple layers to be the integer part bit width that is finally used to fixed-point output values of the multiple layers; or determining the integer part bit width that is finally used according to other standards or preset rules, which is not limited in the embodiments of the present disclosure.

The embodiments of the present disclosure also provide a data fixed-point method. The data fixed-point method includes: calculating a maximum output value in a first target layer of a neural network for each of a plurality of input samples; selecting a maximum output value from a plurality of maximum output values as a fixed-point reference value; and determining a reference integer part bit width according to the fixed-point reference value, to be an integer part bit width used by the first target layer when output values are fixed-pointed.

It should be understood that selecting a maximum output value from a plurality of maximum output values as a fixed-point reference value may be done according to a preset rule. For example, a maximum output value with a largest value is selected from the plurality of maximum output values as the fixed-point reference value; or a maximum output value with a next largest value is selected from the plurality of maximum output values as the fixed-point reference value; or from the plurality of maximum output values, a maximum output value with a value in a middle position is selected as the fixed-point reference value; or the plurality of maximum output values are sorted, and a maximum output value is selected from the plurality of maximum output values based on preset selection parameters, to be the fixed-point reference value; and the like. The embodiments of the present disclosure do not limit the specific selection methods.

Optionally, as one embodiment, determining a reference integer part bit width according to the fixed-point reference value, to be an integer part bit width used by the first target layer when output values are fixed-pointed, includes: determining the reference integer part bit width according to the fixed-point reference value; and performing an accuracy test based on a preset output value total bit width and the reference integer part bit width, and using the reference integer part bit width as the integer part bit width used by the first target layer when output values are fixed-pointed, when the accuracy is not less than a preset threshold.

In an alternative example, for example, a preset threshold is 85%. When a maximum output value with a next largest value is selected from the plurality of maximum output values as the fixed-point reference value, and a corresponding reference integer part bit width makes an accuracy rate not less than 85%, then the corresponding reference integer part bit width is used as the integer part bit width used by the first target layer when output values are fixed-pointed. When a maximum output value with a next largest value is selected from the plurality of maximum output values as the fixed-point reference value, and a corresponding reference integer part bit width makes the accuracy rate less than 85%, then a maximum output value with a largest value is selected from the plurality of maximum output values as the fixed-point reference value to recalculate a reference integer part bit width. When the recalculated reference integer part bit width makes an accuracy rate not less than 85%, then the recalculated reference integer part bit width is used as the integer part bit width used by the first target layer when output values are fixed-pointed. It should be understood that this is only an alternative example of determining the integer part bit width used by the first target layer when output values are fixed-pointed, and is not a limitation on the embodiments of the present disclosure.

The data fixed-point method according to the embodiments of the present disclosure has been described in detail above, and a data fixed-point device according to the embodiments of the present disclosure is described in detail below.

FIG. 11 is a schematic block diagram of a data fixed-point device 600 according to an exemplary embodiment of the present disclosure. The data fixed-point device 600 includes: a forward propagation calculation module 610, a fixed-point reference selection module 620, a reference bit width determination module 630, and an accuracy test module 640.

The forward propagation calculation module 610 is configured to calculate a maximum output value in a first target layer of a neural network for each input sample of a plurality of input samples.

The fixed-point reference selection module 620 is configured to select at least two maximum output values from a plurality of maximum output values obtained by the forward propagation calculation module 610 as fixed-point reference values.

The reference bit width determination module 630 is configured to determine a reference integer part bit width according to each of the fixed-point reference values selected by the fixed-point reference selection module 620.

The accuracy test module 640 is configured to perform an accuracy test based on a preset output value total bit width and each reference integer part bit width determined by the reference bit width determination module 630, and determine a reference integer part bit width with a highest accuracy as an integer part bit width used by the first target layer when output values are fixed-pointed.

The data fixed-point device 600 according to the embodiments of the present disclosure selects multiple values from a plurality of maximum output values in a first target layer as fixed-point reference values, determines a reference integer part bit width according to each of the fixed-point reference values, and determines an optimal integer part bit width based on accuracy tests. Basing on the optimal integer part bit width can make a network after fixed-pointing to transmit more useful information while maintaining high accuracy, and improve expression ability and accuracy of the network.

Optionally, as one embodiment, the fixed-point reference selection module 620 selects at least two maximum output values from a plurality of maximum output values as fixed-point reference value, which may include: the fixed-point reference selection module 620 sorts the plurality of maximum output values, and select at least two maximum output values from the plurality of maximum output values as the fixed-point reference values, according to preset selection parameters.

Optionally, as one embodiment, the reference bit width determination module 630 determines a reference integer part bit width according to each of the fixed-point reference values, which includes: the reference bit width determination module 630 determines the reference integer part bit width according to a size of the fixed-point reference values. The reference bit width determination module 630 is further configured to determine a preset first sign bit width and a preset output value total bit width; and determine a reference fractional part bit width according to the preset first sign bit width, the preset output value total bit width, and the reference integer part bit width.

Optionally, as one embodiment, the data fixed-point device 600 may further include a weight bit width determination module, configured to determine a preset weight fixed-point total bit width and a preset second sign bit width for weight coefficients, determine a weight integer part bit width according to a size of a largest weight coefficient in a first target layer, and determine a weight fractional part bit width according to the preset weight fixed-point total bit width, the preset second sign bit width, and the weight integer part bit width, where the preset second sign bit width, the weight integer part bit width, and the weight fractional part bit width are determined as a sign bit width, an integer part bit width, and a fractional part bit width used by the first target layer when weight coefficients are fixed-pointed.

Optionally, as one embodiment, the data fixed-point device 600 may further include a preprocessing module, configured to perform merging and preprocessing on at least two layers of a neural network to obtain a first target layer formed after merging.

Optionally, as one embodiment, a maximum output value is a maximum output value in a first target layer formed after merging for each input sample of a plurality of input samples.

Optionally, as one embodiment, a maximum weight coefficient is a maximum value of weight coefficients of a first target layer formed after merging and preprocessing at least two layers of a neural network.

Optionally, as one embodiment, the preprocessing module merges and preprocesses at least two layers of a neural network to obtain a first target layer formed after merging, which includes: the preprocessing module performs merging and preprocessing on a convolution layer and a BN layer of the neural network to obtain the first target layer; or the preprocessing module performs merging and preprocessing on a convolution layer and a Scale layer of the neural network to obtain the first target layer; or the preprocessing module performs merging and preprocessing on a convolution layer, a BN layer, and a Scale layer of the neural network to obtain the first target layer.

Optionally, as one embodiment, a first target layer is one layer of, or a layer merged from at least two layers of a convolution layer, a transposed convolution layer, a BN layer, a Scale layer, a pooling layer, a fully connected layer, a Concatenation layer, an element-wise addition layer, and an activation layer.

Optionally, as one embodiment, the data fixed-point device 600 further includes an alignment module, configured to determine an integer part bit width used by a second target layer of a neural network when output values are fixed-pointed, so that the integer part bit width used by the second target layer when output values are fixed-pointed is equal to an integer part bit width used by a first target layer when output values are fixed-pointed.

Optionally, as one embodiment, a fractional part bit width used by a second target layer when output values are fixed-pointed is equal to a fractional part bit width used by a first target layer when output values are fixed-pointed.

Optionally, as one embodiment, the alignment module determines an integer part bit width used by a second target layer of a neural network when output values are fixed-pointed, which includes: the alignment module determines a maximum value of integer part bit widths used by a first target layer and a second target layer when output values are fixed-pointed as an integer part bit width that is finally used by the first target layer and the second target layer when output values are fixed-pointed.

Optionally, as one embodiment, output values of a first target layer and output values of a second target layer are post-processed at a Concatenation layer and/or an element-wise addition layer.

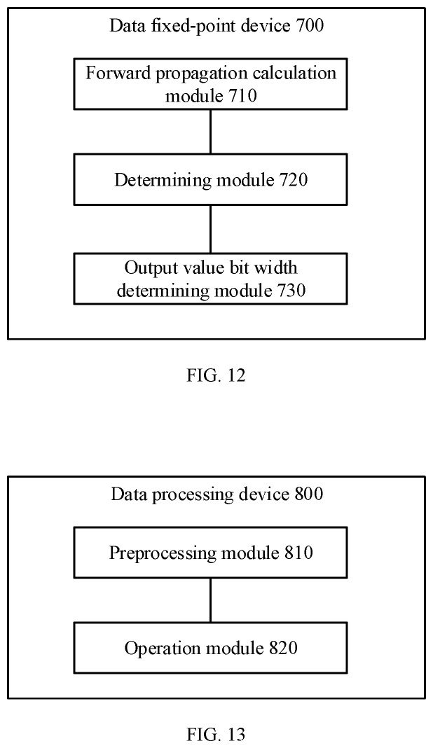

FIG. 12 is a schematic block diagram of a data fixed-point device 700 according to an exemplary embodiment of the present disclosure. The data fixed-point device 700 includes: a forward propagation calculation module 710, a determining module 720, and an output value bit width determining module 730.

The forward propagation calculation module 710 is configured to calculate a reference output value of an input sample in a first target layer of a neural network.

The determining module 720 is configured to determine a preset output value total bit width and a preset first sign bit width for output values.

The output value bit width determining module 730 is configured to determine an output value integer part bit width according to a size of the reference output value obtained by the forward propagation calculation module 710; and determine an output value fractional part bit width, based on the preset output value total bit width and the preset first sign bit width according to the determining module 720 and the output value integer part bit width, where the preset first sign bit width, the output value integer part bit width, and the output value fractional part bit width are used as a sign bit width, an integer part bit width, and a fractional part bit width used by the first target layer when output values are fixed-pointed.

The data fixed-point device in the embodiments of the present disclosure considers a sign bit when output values are fixed-pointed, so that a determined fixed-point solution is better, and possibility of increasing the accuracy of the network is improved.

Optionally, as one embodiment, a reference output value may be a maximum output value of an input sample in a first target layer.

Optionally, as one embodiment, the data fixed-point device 700 may further include a weight bit width determining module, configured to determine a preset weight fixed-point total bit width and a preset second sign bit width for weight coefficients, determine a weight integer part bit width according to a size of a largest weight coefficient in a first target layer, and determine a weight fractional part bit width according to the weight fixed-point total bit width, the preset second sign bit width, and the weight integer part bit width, where the preset second sign bit width, the weight integer part bit width, and the weight fractional part bit width are determined as a sign bit width, an integer part bit width, and a fractional part bit width used by the first target layer when weight coefficients are fixed-pointed.

Optionally, as one embodiment, the data fixed-point device 700 may further include a preprocessing module, configured to perform merging and preprocessing on at least two layers of a neural network to obtain a first target layer formed after merging.

Optionally, as one embodiment, a reference output value is a reference output value in a first target layer formed after merging for each of a plurality of input samples.

Optionally, as one embodiment, a maximum weight coefficient is a maximum value of weight coefficients of a first target layer formed after merging and preprocessing at least two layers of a neural network.

Optionally, as one embodiment, the preprocessing module merges and preprocesses at least two layers of a neural network to obtain a first target layer formed after merging, which includes: the preprocessing module performs merging and preprocessing on a convolution layer and a BN layer of the neural network to obtain the first target layer; or, the preprocessing module performs merging and preprocessing on a convolution layer and a Scale layer of the neural network to obtain the first target layer; or the preprocessing module performs merging and preprocessing on a convolution layer, a BN layer, and a Scale layer to obtain the first target layer.

Optionally, as one embodiment, a first target layer is one layer of, or a layer merged from at least two layers of a convolution layer, a transposed convolution layer, a BN layer, a Scale layer, a pooling layer, a fully connected layer, a Concatenation layer, an element-wise addition layer, and an activation layer.

Optionally, as one embodiment, the data fixed-point device 700 may further include an alignment module, configured to determine an integer part bit width used by a second target layer of a neural network when output values are fixed-pointed, so that the integer part bit width used by the second target layer when output values are fixed-pointed is equal to an integer part bit width used by a first target layer when output values are fixed-pointed.

Optionally, as one embodiment, a fractional part bit width used by a second target layer when output values are fixed-pointed is equal to a fractional part bit width used by a first target layer when output values are fixed-pointed.

Optionally, as one embodiment, output values of a first target layer and output values of a second target layer are post-processed at a Concatenation layer and/or an element-wise addition layer.

FIG. 13 is a schematic block diagram of a data processing device 800 according to an exemplary embodiment of the present disclosure. The data processing device 800 includes: a preprocessing module 810 and an operation module 820.

The preprocessing module 810 is configured to perform merging and preprocessing on at least two layers of a neural network.

The operation module 820 is configured to perform neural network operations based on the neural network after performing the merging and the preprocessing by the preprocessing module 810.

The data processing device according to the embodiments of the present disclosure performs merging and preprocessing on at least two layers of a neural network, and performs neural network operations based on the neural network after performing the merging and the preprocessing, which can save computing resources and improve system efficiency.

Optionally, as one embodiment, the preprocessing module 810 performs merging and preprocessing on the at least two layers of a neural network, which may include: the preprocessing module performs merging and preprocessing on a convolution layer and a BN layer of the neural network; or, the preprocessing module performs merging and preprocessing on a convolution layer and a Scale layer of the neural network; or, the preprocessing module performs merging and preprocessing on a convolution layer, a BN layer, and a Scale layer of the neural network.

Optionally, as one embodiment, the data processing device 800 may further include a determining module, configured to determine a weight coefficient of a first target layer formed after performing the merging and the preprocessing one the at least two layers.

Optionally, as one embodiment, the operation module 820 performs neural network operations on a neural network after performing the merging and the preprocessing, which may include: the operation module 820 performs fixed-point calculations on a first target layer formed after performing the merging and the preprocessing on the at least two layers.

Optionally, as one embodiment, the operation module 820 performs fixed-point calculations on a first target layer formed after performing the merging and the preprocessing on the at least two layers, which may include: the operation module 820 determines an integer part bit width used by the first target layer formed after performing the merging and the preprocessing according to the data fixed-point method 100 or 200 described above.

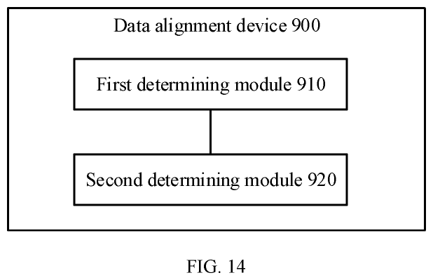

FIG. 14 is a schematic block diagram of a data alignment device 900 according to an exemplary embodiment of the present disclosure. The data alignment device 900 includes: a first determining module 910 and a second determining module 920.

The first determining module 910 is configured to determine multiple layers requiring data alignment from a neural network.

The second determining module 920 is configured to determine an integer part bit width that is finally used to fixed-point output values of the multiple layers according to an integer part bit width that should be used to fixed-point output values of each of the multiple layers, where the integer part bit widths finally used by any two layers of the multiple layers to fixed-point output values are equal to each other.

The data alignment device in the embodiments of the present disclosure can solve the problem that some layers have input data alignment requirements when determining a fixed-point solution, can reduce a use of hardware resources, and improve system efficiency.

Optionally, as one embodiment, the data alignment device 900 may further include a third determining module, configured to determine an integer part bit width that should be used for fixed-pointing output values of each layer of the multiple layers according to the data fixed-point method 100 or 200 described above.

Optionally, as one embodiment, fractional part bit widths to fixed-point output values finally used by any two layers of the multiple layers are equal.

Optionally, as one embodiment, the second determining module 920 determines the integer part bit width that is finally used to fixed-point output values of the multiple layers, which includes: the second determining module determines a maximum value of all the integer part bit widths that should be used for fixed-pointing output values of the multiple layers to be an integer part bit width that is finally used to fixed-point output values of the multiple layers.

One embodiment of the present disclosure further provides a data fixed-point device. The data fixed-point device includes: a forward propagation calculation module for calculating a maximum output value in a first target layer of a neural network for each input sample of a plurality of input samples; a fixed-point reference selection module for selecting a maximum output value from a plurality of maximum output values obtained by the forward propagation calculation module as a fixed-point reference value; and a bit width determination module used to determine a reference integer part bit width according to the fixed-point reference value selected by the fixed-point reference selection module as an integer part bit width used by the first target layer when output values are fixed-pointed.

Optionally, as one embodiment, the bit width determination module determines the reference integer part bit width according to the fixed-point reference value selected by the fixed-point reference selection module as the integer part bit width used by the first target layer when output values are fixed-pointed, which may include: the bit width determination module determines the reference integer part bit width according to the fixed-point reference value; and the bit width determination module performs an accuracy test based on a preset output value total bit width and the reference integer part bit width, and uses the reference integer part bit width as an integer part bit width used by the first target layer when output values are fixed-pointed, when the accuracy is not less than a preset threshold.

It should be understood that the devices according to the embodiments of the present disclosure may be implemented based on a memory and a processor. The memory is used to store instructions for executing the methods according to the embodiments of the present disclosure. The processor executes the foregoing instructions, so that the devices execute the methods according to the embodiments of the present disclosure.

It should be understood that the processor mentioned in the embodiments of the present disclosure may be a Central Processing Unit (CPU), other general-purpose processors, digital signal processors (DSPs), application-specific integrated circuits (ASIC), off-the-shelf Field Programmable Gate Array (FPGA) or other programmable logic devices, discrete gates or transistor logic devices, discrete hardware components, etc. A general-purpose processor may be a microprocessor or the processor may be any conventional processor or the like.

It should also be understood that the memory mentioned in the embodiments of the present disclosure may be a volatile memory or a non-volatile memory, or may include both volatile and non-volatile memories. The non-volatile memory may be a read-only memory (ROM), a programmable read-only memory (PROM), an erasable PROM (EPROM), or an electrically EPROM (EEPROM) or a flash memory. The volatile memory may be a Random-Access Memory (RAM), which is used as an external cache. As exemplary but not limiting examples, many forms of RAM can be used, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DR RAM).

It should be noted that when the processor is a general-purpose processor, a DSP, an ASIC, an FPGA or other programmable logic device, discrete gates or transistor logic devices, or discrete hardware components, the memory (memory module) is integrated in the processor.

It should be noted that the memory described herein is intended to include, but is not limited to, these and any other suitable types of memories.

One embodiment of the present disclosure further provides a computer-readable storage medium having instructions stored thereon. When the instructions are run on a computer, the computer is caused to execute the methods of the foregoing method embodiments.

One embodiment of the present disclosure further provides a computing device, where the computing device includes the computer-readable storage medium described above.

The embodiments of the present disclosure can be applied in the field of aircraft, especially in the field of unmanned aerial vehicles.

It should be understood that divisions of circuits, sub-circuits, and sub-units in the embodiments of the present disclosure are merely schematic. Those of ordinary skill in the art may realize that the circuits, sub-circuits, and sub-units of the examples described in the embodiments disclosed herein can be split or combined again.

The above embodiments may be implemented in whole or in part by software, hardware, firmware, or any combination thereof. When implemented by software, the embodiments may be implemented in whole or in part in a form of a computer program product. The computer program product includes one or more computer instructions. When the computer instructions are loaded and executed on a computer, the processes or functions according to the embodiments of the present disclosure are implemented in whole or in part. The computer may be a general-purpose computer, a special purpose computer, a computer network, or other programmable device. The computer instructions may be stored in or transmitted from one computer-readable storage medium to another computer-readable storage medium, for example, the computer instructions may be transmitted from a website site, a computer, a server, or a data center to another website site, another computer, another server or another data center via wired means (such as a coaxial cable, an optical fiber, a digital subscriber line (DSL)) or wireless means (such as infrared, wireless, microwave, etc.). The computer-readable storage medium may be any available medium that can be accessed by a computer or a data storage device such as a server, a data center, or the like that includes one or more available medium integration. The available medium may be a magnetic medium (for example, a floppy disk, a hard disk, a magnetic tape), an optical medium (for example, a digital video disc (DVD)), or a semiconductor medium (for example, a solid state disk (SSD)), etc.

It should be understood that the embodiments of the present disclosure are described by taking a total bit width of 16 bits as an example, and the embodiments of the present disclosure may be applicable to other bit widths.

It should be understood that “one embodiment” or “an embodiment” mentioned throughout the specification means that a particular feature, structure, or characteristic related to the embodiments is included in at least one embodiment of the present disclosure. Thus, the appearances of “in one embodiment” or “in an embodiment” appearing throughout the specification are not necessarily referring to a same embodiment. Furthermore, the particular features, structures, or characteristics may be combined in any suitable manner in one or more embodiments.

It should be understood that, in various embodiments of the present disclosure, values of sequence numbers of the above processes do not mean an order of execution. The execution order of each process should be determined by its function and internal logic, and should not constitute any limitation on implementation processes of the embodiments of the present disclosure.

It should be understood that in the embodiments of the present disclosure, “B corresponding to A” means that B is associated with A, and B can be determined according to A. However, it should also be understood that determining B based on A does not mean determining B based solely on A, but also determining B based on A and/or other information.

It should be understood that a term “and/or” herein is only an association relationship describing an associated object, and indicates that there can be three kinds of relationships, for example, A and/or B can mean three cases: A exists alone, A and B exist simultaneously, and B exists alone. In addition, a character “/” in this text generally indicates that the related objects are in an “or” relationship.

Those skilled in the art can clearly understand that, for convenience and brevity of description, specific working processes of the systems, devices, and units described above can refer to the corresponding processes in the foregoing method embodiments, and are not repeated here.

Those of ordinary skill in the art may realize that units and algorithm steps of each example described in combination with the embodiments disclosed herein can be implemented by electronic hardware, or a combination of computer software and electronic hardware. Whether these functions are performed by hardware or software depends on a specific application and design constraints of the technical solution. A professional technician can use different methods to implement the described functions for each specific application, but such implementation should not be considered to be beyond the scope of the present disclosure.

In the embodiments provided in the present disclosure, it should be understood that the disclosed systems, devices, and methods may be implemented in other ways. For example, the device embodiments described above are only schematic. For example, a division of units is only a logical function division. In an actual implementation, there may be another division manner. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may be electrical, mechanical or other forms.

The units described as separate components may or may not be physically separated, and the components displayed as units may or may not be physical units, that is, may be located in one place, or may be distributed on multiple network units. Some or all of the units may be selected according to actual needs to achieve the objective of the solution of the embodiments.

In addition, each functional unit in each embodiment of the present disclosure may be integrated into one processing unit, or each of the units may exist separately physically, or two or more units may be integrated into one unit.

The above are only alternative implementations of the present disclosure, but the scope of protection of the present disclosure is not limited to these. Any person skilled in the art can easily think of changes or replacements within the technical scope disclosed in the present disclosure, which should be covered by the protection scope of the present disclosure. Therefore, the protection scope of the present disclosure shall be subject to the protection scope of the claims.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A data fixed-point method, comprising:
calculating a maximum output value in a first target layer of a neural network for each input sample of a plurality of input samples;
selecting at least two of a plurality of maximum output values as fixed-point reference values;
determining a reference integer part bit width according to each of the fixed-point reference values; and
performing an accuracy test based on a preset output value total bit width and each reference integer part bit width, to determine a reference integer part bit width with a highest accuracy as an integer part bit width used by the first target layer when output values are fixed-pointed.

2. The method of claim 1, wherein selecting at least two of the plurality of maximum output values as the fixed-point reference values includes:
sorting the plurality of maximum output values, and selecting at least two of the plurality of maximum output values as the fixed-point reference values according to preset selection parameters.

3. The method of claim 1, wherein determining the reference integer part bit width according to each of the fixed-point reference values includes:
determining the reference integer part bit width according to a size of the fixed-point reference values,
the method further comprising:
determining a preset first sign bit width and the preset output value total bit width; and
determining a reference fractional part bit width according to the preset first sign bit width, the preset output value total bit width, and the reference integer part bit width.

4. The method of claim 1, further comprising:
determining a preset weight fixed-point total bit width and a preset second sign bit width for weight coefficients;
determining a weight integer part bit width according to a size of a maximum weight coefficient in the first target layer; and
determining a weight fractional part bit width according to the preset weight fixed-point total bit width, the preset second sign bit width, and the weight integer part bit width, wherein:
the preset second sign bit width, the weight integer part bit width, and the weight fractional part bit width are determined as a sign bit width, an integer part bit width, and a fractional part bid width used by the first target layer when weight coefficients are fixed-pointed.

5. The method of claim 4, wherein:
the maximum weight coefficient is a maximum value of weight coefficients in a first target layer formed after merging and preprocessing at least two layers of the neural network.

6. The method of claim 1, further comprising:
merging and preprocessing at least two layers of the neural network to form a first target layer formed after merging.

7. The method of claim 6, wherein:
the maximum output value is a maximum output value in the first target layer formed after merging for each input sample of the plurality of input samples.

8. The method of claim 6, wherein merging and preprocessing the at least two layers of the neural network to form the first target layer formed after merging includes:
merging and preprocessing a convolution layer and a Batch Normalization layer of the neural network to form the first target layer; or
merging and preprocessing a convolution layer and a Scale layer of the neural network to form the first target layer; or
merging and preprocessing a convolution layer, a Batch Normalization layer, and a Scale layer of the neural network to form the first target layer.

9. The method of claim 1, wherein:
the first target layer includes a convolution layer, a transposed convolution layer, a Batch Normalization layer, a Scale layer, a pooling layer, a fully connected layer, a Concatenation layer, an element-wise addition layer, an activation layer, or a combination thereof.

10. The method of claim 1, further comprising:
determining an integer part bit width used by a second target layer of the neural network when output values are fixed-pointed, wherein the integer part bit width used by the second target layer when output values are fixed-pointed is equal to the integer part bit width used by the first target layer when output values are fixed-pointed.

11. The method of claim 10, wherein determining the integer part bit width used by the second target layer of the neural network when the output values are fixed-pointed includes:
determining a maximum value of the integer part bit widths that should be used by the first target layer and the second target layer when output values are fixed-pointed as an integer part bit width finally used by the first target layer and the second target layer when output values are fixed-pointed.

12. The method of claim 10, wherein:
output values of the first target layer and output values of the second target layer are postprocessed in a Concatenation layer and/or an element-wise addition layer.

13. A data fixed-point method, comprising:
calculating a reference output value of an input sample in a first target layer of a neural network;
determining a preset output value total bit width and a preset first sign bit width;
determining an output value integer part bit width according to a size of the reference output value; and
determining an output value fractional part bit width according to the preset output value total bit width, the preset first sign bit width, and the output value integer part bit width, wherein the preset first sign bit width, the output value integer part bit width, and the output value fractional part bit width are used as a sign bit width, an integer part bit width, and a fractional part bit width used by the first target layer when output values are fixed-pointed.

14. The method of claim 13, wherein:
the reference output value is a maximum output value of the input sample in the first target layer.

15. The method of claim 13, further comprising:
determining a preset weight fixed-point total bit width and a preset second sign bit width for weight coefficients;
determining a weight integer part bit width according to a size of a maximum weight coefficient in the first target layer; and
determining a weight fractional part bit width according to the preset weight fixed-point total bit width, the preset second sign bit width, and the weight integer part bit width, wherein:
the preset second sign bit width, the weight integer part bit width, and the weight fractional part bit width are determined as a sign bit width, an integer part bit width, and a fractional part bit width used by the first target layer when weight coefficients are fixed-pointed.

16. The method of claim 15, wherein:
the maximum weight coefficient is a maximum value of weight coefficients of a first target layer formed after merging and preprocessing at least two layers of the neural network.

17. The method of claim 13, further comprising:
merging and preprocessing at least two layers of the neural network to form a first target layer formed after merging.

18. The method of claim 17, wherein:
the reference output value is a reference output value in the first target layer formed after merging for each input sample of a plurality of input samples.

19. The method of claim 17, wherein merging and preprocessing the at least two layers of the neural network to form the first target layer formed after merging includes:
merging and preprocessing a convolution layer and a Batch Normalization layer of the neural network to form the first target layer; or
merging and preprocessing a convolution layer and a Scale layer of the neural network to form the first target layer; or
merging and preprocessing a convolution layer, a Batch Normalization layer, and a Scale layer of the neural network to form the first target layer.

20. A data processing method, comprising:
performing merging and preprocessing on at least two layers of a neural network; and
performing neural network operations based on the neural network after performing the merging and the preprocessing.
